(19) United States
(12) Patent Application Publication
(10) Pub. No.: US 2013/0052075 A1
(43) Pub. Date: Feb. 28, 2013

(54) METHOD FOR THE MANUFACTURE OF A WEAR PAD FOR A BAND SAW BLADE GUIDE, SUCH A WEAR PAD, AND THE USE OF A STEEL MATERIAL FOR PRODUCING THE WEAR PAD

(71) Applicant: Jan Boström, Hagfors (SE)

(72) Inventor: Jan Boström, Hagfors (SE)

(21) Appl. No.: 13/634,963

(22) PCT Filed: Mar. 9, 2011
(86) PCT No.: PCT/SE2011/050256

§ 371 Date: Nov. 14, 2012

(30) Foreign Application Priority Data
Mar. 17, 2010 (SE) 1050244-1

(51) Int. Cl. B22F 3/15; B32B 15/02; B22F 3/24

(52) U.S. Cl. 419/13; 419/16; 419/17; 75/236; 75/238; 75/244

(57) ABSTRACT

A wear pad of a band saw guide exposed to wear from a moving band saw blade is produced in a powder metallurgical manner from a steel material having the following composition, in percent by weight: 0.01-2 C, 0.01-3.0 Si, 0.01-10.0 Mn, 16-33 Cr, max. 5 Ni, 0.01-5.0 (W+Mo/2), max. 9 Co, max. 0.5 S, 1.6-9.8 N, 7.5 to 14 of (V+Nb/2), wherein the contents of N and of (V+Nb/2) are balanced in relation to each other so that the contents of the elements are within a range I″, F″, G, H, I″ in a coordinate system, where the content of N is the abscissa and the content of (V+Nb/2) is the ordinate, and where the coordinates for the points (in the format [x: (N, (V+Nb/2)]) are [I″: (1.6, 7.5)], [F″: (5.8, 7.5)], [G: (9.8, 14.0)], and [H: (2.6, 14.0)], max 7 of any of Ti, Zr, and Al; and a balance essentially only iron and unavoidable impurities.

### TECHNICAL FIELD

The present invention relates to a method for the manufacture of a wear pad of a band saw blade guide exposed to wear from a moving band saw blade.

The present invention also relates to a wear pad of a band saw blade guide exposed to wear from a moving band saw blade.

Further, the invention relates to the use of a steel material for powder metallurgical production of a wear pad of a band saw blade guide exposed to wear from a moving band saw blade.

### PRIOR ART

Band saws are typically characterized by a band saw motor and blade combination which is operated to drive a flexible, continuous, serrated blade in an orbit or path for cutting a variety of materials including lumber, wood stock, metals, ceramics and plastics. Because the band saw blade is typically trained around a pair of spaced-apart blade drive wheels, the cutting plane of the orbiting band saw blade may be vertical plane or horizontal, and a mechanism must be provided which guides the cutting segment of the vertical blade through the horizontal or vertical path of travel. Moreover, because the blade is thin and flexible, it is subject to extensive vibration and distortion during the sawing operation, which could result in an uneven cut in the work stock if the band saw blade is not adequately stabilized in the horizontal or vertical cutting plane. Accordingly, blade guiding or stabilizing mechanisms are a well-known expedient in the band saw art.

Such a band saw blade guiding mechanism is disclosed in U.S. Pat. No. 3,534,647 and comprises a pair of support arms that extends between a pair of vertically-spaced drive pulleys, upon which is trained a continuous band saw blade. A blade guide assembly provided on the extending end of each support arm receives the blade and carbide inserts are fitted in the blade guide assemblies for contacting the opposite surfaces of the blade and minimizing vibration of the cutting segment of the blade between the blade guide assemblies as the blade is driven on the drive pulleys.

Usually, the carbide is cemented carbide, also called tungsten-carbide cobalt or hardmetal, which is a metal matrix composite, where tungsten carbide particles are the aggregate, and metallic cobalt serves as the matrix. For several decades, cemented carbide has been substituted for steel in applications where the performance of steel was unsatisfactory, and blocks of cemented carbide were attached to a suitable substrate by brazing. The main problem with a wear pad with blocks of cemented carbide is its life, which is ended by cracking or chipping of the cemented carbide. Further, wear pads with blocks of cemented carbide are expensive.

U.S. Pat. Nos. 6,889,589 B1 and 7,325,473 B2 disclose a guide for stabilizing the saw blade of a saw mill assembly. The guide includes a guide block having a first surface for engaging a surface of a saw blade and a second opposing surface. The guide block or insert is bi-metallic such that the metallic material proximal to a first blade-engaging surface thereof is harder than the metallic material proximal to a second guide-engaging surface. The harder material preferably is an austenitic chromium-carbide alloy having a Brinell hardness number between 460 and 614.

Further, WO 2007/024192 A1 (Uddeholm Tooling Aktiebolag) describes a powder metallurgically produced steel alloy as well as tools and components made of the alloy. The alloy has the following composition in weight-%: 0.01 to 2 C, 0.6 to 10 N, 0.01 to 3.0 Si, 0.01 to 10.0 Mn, 16 to 30 Cr, 0.01 to 5 Ni, 0.01 to 5.0 (Mo+W/2), 0.01 to 9 Co, max. 0.5 S, and 0.5 to 14 (V+Nb/2), wherein the contents of N, on one hand, and of (V+Nb/2), on the other hand, have been balanced in relation to each other, so that the contents of these elements are in an area defined by the coordinates A′, B′, G, H, A′, where the [N, (V+Nb/2)]-coordinates for these points are: A′: [0.6, 0.5]; B′: [1.6, 0.5]; G: [9.8, 14.0]; H: [2.6, 14.0], as well as max. 7 of any of Ti, Zr and Al, balance essentially only iron and impurities in normal contents. The steel is intended to be used for the manufacture of tools for injection molding, compression molding and extrusion of plastic components as well as of cold work tools which are subjected to corrosion. Further, also engineering components, e.g. injection nozzles for engines, wear metal components, pump components, bearing components, etc. An additional application field is the use of the steel alloy for the manufacture of knives for the food industry. WO 2007/024192 A1 is incorporated herein by reference.

### DISCLOSURE OF THE INVENTION

An object of the present invention is to provide a method for the manufacture of a wear pad of a band saw blade guide, which will have a longer life and also are less expensive than wear pads using cemented carbides.

In the method described in the first paragraph above, this object is achieved in accordance with the invention in accordance with the appended claims.

A steel wear pad of the above composition has a significantly better life time, i.e. more than twice the life of a wear pad using cemented carbide. Furthermore, it is substantially less expensive, i.e. about half the price of a wear pad using cemented carbide. On top of that there exist the important advantage that a wear pad according to the invention docs not crack or chip, leading to a increased degree of utilization, since it eliminates sudden breakdown of the band saw, that do occur now and then with wear pad using cemented carbide. Hence, any need of exchange of a pad may be easily predicted and therefore planned in conjunction with other kind of maintenance. Further, it can be ground when worn, and then used repeatedly for another service period, while the cracked or chipped blocks of cemented carbide have to be removed from the substrate and new blocks brazed onto the substrate. In addition, the steel wear pad of the above composition results in an environmental benefit since it provides reduced noise level, which in turn also reduces vibrations in the band saw blade and thereby possibly increases the life of the band saw machine. All in all it is evident that the invention provides surprising synergies.

In addition to the advantages referred to above in connection with the method of the invention, the wear resistant material of the composition mentioned above in a preferred embodiment is balanced regarding the content of nitrogen in relation to the content of vanadium and possibly occurring niobium. The microstructure has a high content of very hard, stable hard phase particles, and a wear surface may be achieved which easily fulfils very high requirements for anti-galling and anti-fretting properties at the same time as it has very good properties against corrosion, in accordance with claim 8.

Still another object of the present invention is to provide a use of a steel material for powder metallurgical production of a wear pad of a band saw blade guide exposed to wear from a moving band saw blade, which will have a longer life than wear pads using cemented carbides, in accordance with claim 10.

In this way, it will be possible to use the powder metallurgically produced steel material for wear pads requiring very good wear resistance in the surface region of the product at the same time as the product preferably fulfils requirements for corrosion resistance, workability, ductility, machinability, hardness, hot treatment response both regarding substrate and wear layer.

Additional characteristic features of the different embodiments of the invention and what is obtained therewith will be apparent from the following detailed description and from the claims.

### BRIEF DESCRIPTION OF THE ENCLOSED DRAWINGS

Below, the invention will be described more in detail with reference to preferred embodiments and to the enclosed drawings.

FIG. 1 shows the proportion between the content of N and the content of (V+Nb/2) for the steel used, in the form of a coordinate system,

FIG. 2 is a graph showing wear resistance,

FIG. 3 is a graph showing the corrosion resistance,

FIG. 4 shows the microstructure of a wear resistant layer made of a powder metallurgically produced steel material which has been hot isostatically pressed, and then heat treated according to a preferred embodiment of the invention,

FIG. 5 is a graph showing the friction properties of Vanax 75,

FIG. 6 is a graph showing the friction properties of Vanax 75,

FIG. 7 is a graph comparing the hardness in relation to the tempering temperature between the wear resistant steel material according to the invention,

FIG. 8 is a side view of an example of a preferred embodiment of a wear pad of the present invention for a band saw blade guide exposed to wear from a moving band saw blade,

FIG. 9 is a plan view of the wear pad of FIG. 8, and,

FIG. 10 is a cross-sectional view taken along line XV-XV in FIG. 9.

### DETAILED DESCRIPTION OF PREFERRED EMBODIMENTS

### The Steel Material

The steel material used in the wear pad of the present invention is powder metallurgically manufactured, which is a condition for the steel being, to a great extent, void of oxide inclusions and obtaining a microstructure comprising an even distribution of up to 50 vol.-% of hard phase particles of M₂X—, MX— and/or M₂₃C₆/M₇C₃ type, the size of which in their longest extension is 1 to 10 μm, wherein the content of said hard phase particles are distributed in such a way that up to 20 vol.-% are M₂X-carbides, -nitrides and/or -carbonitrides, wherein M mainly is V and Cr, and X mainly is N, and 5 to 40 vol.-% of MX-carbides, -nitrides and/or -carbonitrides, wherein M mainly is V, and X mainly is N, wherein the average size of said MX-particles is below 3 μm, preferably below 2 μm, and even more preferred below 1 μm. Preferably, the powder metallurgical manufacturing comprises gas atomizing of a steel melt with nitrogen as the atomizing gas, which gives the steel alloy a certain minimum content of nitrogen. By solid phase nitriding of the powder, higher, desirable nitrogen content may be obtained.

The following is valid for the alloy elements of the steel.

In the first place, carbon shall be present in the steel of the invention in a sufficient amount in order to, together with nitrogen in a solid solution in the matrix of the steel, contribute to giving the steel a high hardness of up to 60 to 62 HRC in its hardened and tempered condition. Together with nitrogen, carbon may also be present in primarily precipitated M₂X-nitrides, -carbides, and/or -carbonitrides, wherein M mainly is V and Cr, and X mainly is N, as well as in primarily precipitated MX-nitrides, -carbides and/or -carbonitrides, wherein M mainly is V, and X mainly is N, as well as in possibly occurring M₂₃C₆— and/or M₇C₃-carbides.

Carbon shall together with nitrogen give the desired hardness and form hard phases included into the steel. The content of carbon in the steel, i.e. carbon which is in solid solution in the matrix of the steel plus the carbon which is bound in carbides and/or carbonitrides, shall be held at as low a level as may be motivated for production economical reason as well as to phase. The steel shall be able to austenitize and be transformable to martensite at the hardening. When necessary, the material is deep frozen to avoid retained austenite. Preferably, the carbon content shall be at least 0.01%, even more preferred at least 0.05%, and most preferred at least 0.1%. The maximum carbon content may be allowed to max. 2%. Depending on the field of application, the carbon content is adapted to the amount of nitrogen in the steel as well as to the total content of the carbide forming elements vanadium, molybdenum and chromium in the steel, in the first place, so that the steel gets a content of M₂X-carbides, -nitrides and/or -carbonitrides of up to 20 vol.-% as well as a content of MX-carbides, -nitrides and/or -carbonitrides of 5 to 40 vol.-%. M₂₃C₆— and/or M₇C₃-carbides may be present in contents up to 8 to 10 weight-%, mainly at very high chromium contents. The total content of MX—, M₂X— and/or M₂₃C₆/M₇C₃-carbides, -nitrides and/or -carbonitrides in the steel shall, however, not exceed 50 vol.-%. Furthermore, the presence of additional carbides in the steel shall be minimized so that the content of dissolved chromium in the austenite is not below 12%. Preferably, the content of dissolved chromium in the austenite is at least 13%, and even more preferred at least 16%, which ensures that the steel obtains a good corrosion resistance.

Nitrogen is an essential alloy element in the steel of the invention. Like carbon, nitrogen shall be present in solid solution in the matrix of the steel to give the steel an adequate hardness and to form the desired hard phases. Preferably, nitrogen is used as an atomizing gas at the powder metallurgical manufacturing process of the metal powder. With such a powder production, the steel will contain max. 0.2 to 0.3% nitrogen. This metal powder may then be given a desired nitrogen content according to any known technique, e.g. by pressurizing in nitrogen gas or by solid phase nitriding of the manufactured powder, and therefore the steel suitably contains at least 1.6%, preferably at least 2.6% nitrogen. As pressurizing in nitrogen gas or solid phase nitriding is used, it is, of course, also possible to allow the atomizing to take place with another atomizing gas, e.g. argon.

In order not to cause brittleness problems and give retained austenite, the nitrogen content is maximized to 9.8%, preferably 8%, and even more preferred max. 6%. As vanadium, but also other strong nitride/carbide formers, e.g. chromium and molybdenum, has a tendency to react with nitrogen and carbon, the carbon content should at the same time be adapted to said high nitrogen content, so that the carbon content is maximized to 2%, suitably max. 1.5%, preferably max. 1.2% for the nitrogen contents mentioned above. In this connection it should, however, be noticed that the corrosion resistance decreases with increased carbon content and that also the galling resistance may decrease, which is a disadvantage, above all because comparatively large chromium carbides, M₂₃C₆ and/or M₇C₃, may be formed as compared to the steel of the invention being given a lower carbon content than the highest contents mentioned above.

In those cases when it is sufficient that the steel has lower nitrogen content, it is therefore desirable to reduce the carbon content too. Preferably, the carbon content is limited to such low levels as may be motivated for economical reasons, but according to the invention the carbon content may be varied at a certain nitrogen content, wherein the content of hard phase particles in the steel and its hardness may be adapted depending on the field of application, for which the steel is intended. At certain contents of the corrosion inhibiting alloy elements, chromium and molybdenum, nitrogen also contribute to promote the formation of MX-carbonitrides and to suppress the formation of M₂₃C₆ and/or M₇C₃ which reduce the corrosion resistance of the steel in an unfavorably way.

Silicon is present as a residual from the manufacture of the steel and may occur in a minimal content of 0.01%. At high contents, silicon gives a solution hardening effect, but also a certain brittleness. Silicon also is a stronger ferrite former and must therefore not be present in amounts exceeding 3.0%. Preferably, the steel does not contain more than max. 1.0% silicon, suitably max. 0.8%. A nominal silicon content is 0.3%.

Manganese contributes to giving the steel good hardenability. To avoid brittleness problems, manganese must not be present in contents exceeding 10.0%. Preferably, the steel does not contain more than max. 5.0% manganese, suitably max. 2.0% manganese. In embodiments where the hardenability is not of as great importance, manganese is present in the steel in low contents as a retained element from the production of the steel and binds the amounts of sulfur which may be present by forming manganese supplied. Manganese should therefore be present in a content of at least 0.01% and a suitable manganese range is 0.2 to 0.4%.

Chromium shall be present in a minimum content of 16%, preferably 17%, and even more preferred at least 18%, to give the steel the desired corrosion resistance. Chromium also is an important nitride former and shall as such en element be present in the steel to, together with nitrogen, give the steel an amount of hard phase particles, which contribute to giving the steel the desired galling and wear resistance. Of said hard phase particles, up to 20 vol.-% may consist of M₂X-carbides, -nitrides and/or -carbonitrides, where M mainly is Cr but also a certain amount of V, Mo and Fe, and 5 to 40% may consist of MX-carbides, -nitrides and/or -carbonitrides, where M mainly is V. However, chromium is a strong ferrite former. In order to avoid ferrite after hardening, the chromium content must not exceed 33%, suitably it amounts to max. 30%, preferably max. 27%, and even more preferred max. 25%.

Nickel is an optional element and may as such possibly be present as an austenite stabilizing element in a content of max. 5.0% and suitably max. 3.0% to balance the high contents of the ferrite forming elements chromium and molybdenum in the steel.

Preferably, the steel of the invention, however, contains no intentionally added amount of nickel. However, nickel may be tolerated as an unavoidable impurity, which as such may be as high as about 0.8%.

Cobalt also is an optional element and may as such possibly be present in a content of max. 9% and suitably max. 5% in order to improve the tempering response.

Molybdenum should be present in the steel, as it contributes to giving the steel the desired corrosion resistance, especially good fretting resistance. However, molybdenum is a strong ferrite former, and therefore the steel must not contain more than max. 5.0%, suitably max. 4.0%, preferably max. 3.5% Mo. A nominal molybdenum content is 1.3%.

Molybdenum may principally completely or partly be replaced by tungsten, which does not, however, give the same improvement of the corrosion resistance. Further, twice as much tungsten as molybdenum is required, which is a disadvantage. In addition, also the scrap metal treatment is more difficult.

Vanadium shall be present in the steel in a content of 7.5 to 11.0, preferably 8.5 to 10.0, and even more preferred 8.8 to 9.2%. A nominal vanadium content is 9.0%. Within the scope of the invention idea, it is also conceivable to allow vanadium contents of up to about 14% in combination with nitrogen contents of up to about 9.8% and carbon contents in the range 0.1 to 2%, which gives the steel the desired properties, especially at the use as hard material coatings in tools with high requirements for corrosions resistance in combination with high hardness (up to 60 to 62 HRC) and a moderate ductility as well as extremely high requirements for wear resistance (abrasive/adhesive galling/fretting).

In principle, vanadium may be replaced by niobium to form MX-nitrides, -carbides and/or -carbonitrides, but in such larger amount is required as compared to vanadium, which is a disadvantage. Further, niobium results in the nitrides, carbides and/or carbonitrides getting a more edged shape and being larger than pure vanadium nitrides, carbides and/or carbonitrides, which may initiate ruptures or chippings and hence reduce the toughness and the polishability of the material. This may be especially detrimental for the steel in those cases when the composition is optimized in order to achieve an excellent wear resistance in combination with good ductility and high hardness, as regards the mechanical properties of the material. In this case, the steel must not contain more than max. 2%, suitably max. 0.5%, preferably max. 0.1% niobium. As to production, there are also problems, as Nb(C, N) may give clogging of the tapping jet from the ladle during the atomizing. According to said first embodiment, the steel must therefore not contain more than 6%, preferably it amounts to max. 2.5%, suitably max. 0.5% niobium. In the most preferred embodiment, niobium is not tolerated more than as an unavoidable impurity in the form of a retained element emanating from the raw metal materials at the manufacture of the steel.

In addition to said alloy elements, the steel need not, and should not, contain any additional alloy elements in significant amounts. Certain elements are expressively undesired, as they influence the properties of the steel in an undesired manner. This is true for e.g. phosphorus, which should be held at as low a level as possible, preferably max. 0.03%, in order not to influence the toughness of the steel in a negative manner. Also sulfur is in most cases an undesired element, but its negative influence on the toughness, above all, may essentially be neutralized by means of manganese, which forms essentially harmless manganese sulfides and may therefore be tolerated in a maximal content of 0.5% in order to improve the machinability of the steel. Titanium, zirconium and aluminum are also in most cases undesired but may together be allowed in a maximal amount of 7%, but normally in considerably lower contents, <0.1% in all.

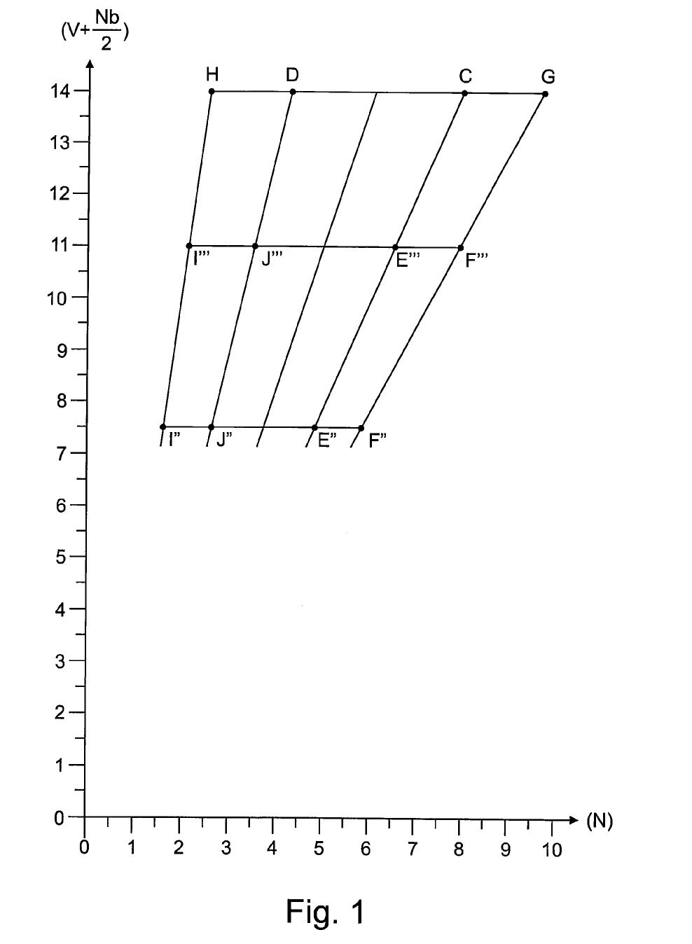

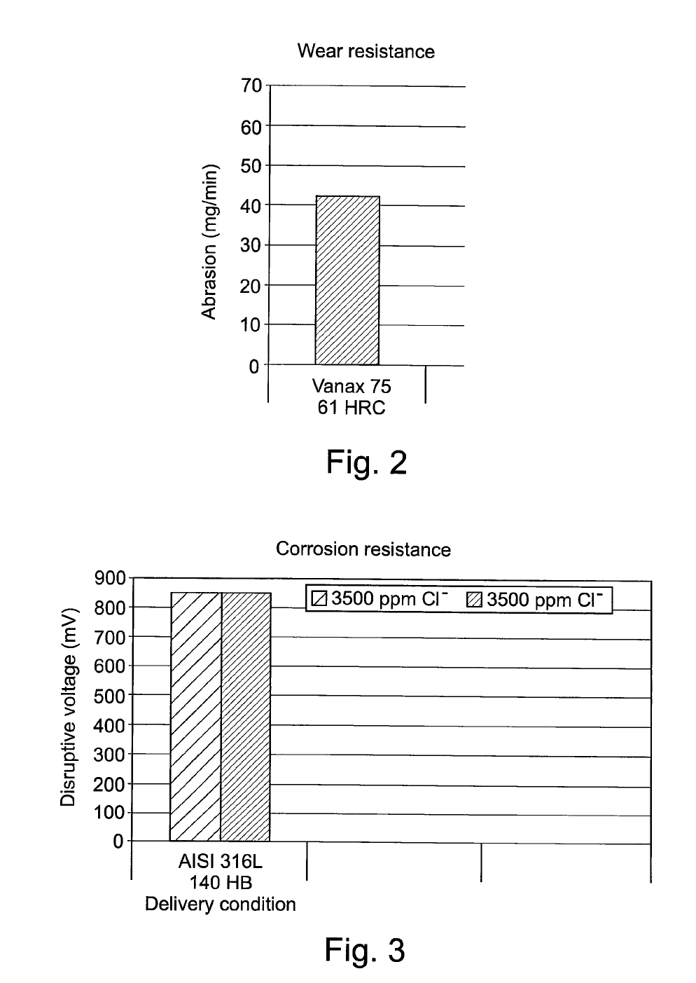

As mentioned, the nitrogen content shall be adapted to the content of vanadium and possibly occurring niobium in the material to give the steel an amount of 5 to 40 vol.-% of MX-carbides, -nitrides and/or -carbonitrides. The conditions for the proportions between N and (V+Nb/2) are shown in FIG. 1, which shows the content of N related to the content (V+Nb/2) for the steel of the invention. The corner points in the areas shown have coordinates according to the table below:

TABLE 1
the proportions between N and (V + Nb/2)

| | N | V + Nb/2 |
|---|---|---|
| C | 8.0 | 14.0 |
| D | 4.3 | 14.0 |
| E″ | 4.8 | 7.5 |
| E′″ | 6.5 | 11.0 |
| F″ | 5.8 | 7.5 |
| F′″ | 8.0 | 11.0 |
| G | 9.8 | 14.0 |
| H | 2.6 | 14.0 |
| I″ | 1.6 | 7.5 |
| I′″ | 2.1 | 11.0 |
| J″ | 2.6 | 7.5 |
| J′″ | 3.5 | 11.0 |

According to a first aspect of the steel used according to the invention, the content of N, on one hand, and of (V+Nb/2), on the other hand, shall be so balanced in relation to each other that the contents of these elements are within a region defined by the coordinates I″, F″, G, H, I″ in the coordinate system of FIG. 1.

According to a first preferred embodiment of the invention, the contents of nitrogen, vanadium and possibly occurring niobium in the steel shall be so balanced in relation to each other that the contents are within the region defined by the coordinates I″, F″, F′″, I′″, I″, and more preferred within J″, E″, E′″, J′″, J″.

Table 2 shows the composition ranges in weight-% for a steel according to the first preferred embodiment of the invention.

TABLE 2

| Element | C | Si | Mn | Cr | Mo | V | N |
|---|---|---|---|---|---|---|---|
| Min. | 0.10 | 0.01 | 0.01 | 18.0 | 0.01 | 7.5 | 2.5 |
| Guideline value | 0.20 | 0.30 | 0.30 | 21.0 | 1.3 | 9.0 | 4.3 |
| Max. | 1.5 | 1.5 | 1.5 | 21.5 | 2.5 | 11 | 6.5 |

The steel according to the first embodiment is suitable to use for wear surfaces of products with high requirements for corrosion resistance in combination with high hardness (up to 60 to 62 HRC) and comparatively good ductility as well as high demands for wear resistance (abrasive/adhesive/galling/fretting). With a composition according to the table, the steel has a matrix, which after hardening from an austenitizing temperature of 1080 and low temperature tempering at 200 to 450° C., 2×2 h, or high temperature tempering at 450 to 700° C., 2×2 h, consists of tempered martensite with a hard phase amount consisting of up to about 3 to 15 vol.-% of M₂X, where M mainly is Cr and V, and X mainly is N, and 15 to 25% of MX, where M mainly is V, and X mainly is N.

Table 3 shows the composition ranges in weight-% for a steel according to an additional, preferred embodiment of the invention.

TABLE 3

| Element | C | Si | Mn | Cr | Mo | V | N |
|---|---|---|---|---|---|---|---|
| Min. | 0.10 | 0.01 | 0.01 | 30.0 | 0.01 | 7.5 | 4.0 |
| Guideline value | 0.20 | 0.30 | 0.30 | 32.0 | 1.3 | 9.0 | 5.6 |
| Max. | 1.5 | 1.5 | 1.5 | 33.0 | 2.5 | 11 | 7.0 |

Within the scope of the idea of the invention, it is also conceivable to allow nitrogen contents of up to about 9.8%, which, in combination with vanadium contents of up to about 14% and carbon contents in the range 0.1 to 2%, gives the steel the desired properties, especially at use for wear surfaces with high requirements for corrosions resistance in combination with high hardness (up to 60 to 62 HRC) and a moderate ductility as well as extremely high requirements for wear resistance (abrasive/adhesive/galling/fretting). The steel according to said embodiment has a matrix, which after hardening from an austenitizing temperature of about 1100° C. and low temperature tempering at 200 to 450° C., 2×2 h, or high temperature tempering at 450 to 700° C., 2×2 h, consists of tempered martensite with a hard phase amount consisting of up to about 2 to 15 vol.-% of M₂X, where M mainly is Cr and V, and X mainly is N, and 15 to 25% of MX, where M mainly is V, and X mainly is N.

The steel according to the embodiments described above has proved to be suitable for use for wear pads of band saw blade guides, which are exposed to wear from a moving band saw blade. Such wear pads are subjected to a great mixed adhesive and abrasive wear, especially galling and fretting.

At the hot working, the wear pad is austenitized at a temperature between 950 and 1150° C., preferably between 1020 and 1130° C., most preferred between 1050 and 1120° C. Higher austenitizing temperatures are in principle conceivable but are unsuitable with regard to the fact that the hardening furnaces normally existing are not adapted to higher temperatures. A suitable holding time at the austenitizing temperature is 10 to 30 min. From said austenitizing temperature the steel is cooled to room temperature or lower, e.g. to −40° C. To eliminate retained austenite in order to give the product the desired dimensional stability, deep freezing may be practiced, which is suitably performed in dry ice to about −70 to −80° C. or in liquid nitrogen at about −196° C. To obtain an optimal corrosion resistance, the tool is low temperature tempered at 200 to 300° C. at least once, preferably twice. If the steel instead is optimized to obtain a secondary hardening, the product is high temperature tempered at least once, preferably twice, and possibly several times at a temperature between 400 and 560° C., preferably at 450 and 525° C. The product is cooled after each such tempering treatment. Preferably, also in this case deep freezing is used as mentioned above in order further to ensure a desired dimensional stability by eliminating possibly remaining retained austenite. The holding time at the tempering temperature may be 1 to 10 h, preferably 1 to 2 h. The composition of the wear resistant steel material gives a very good tempering response.

In connection with the different hot workings, which the wear pad is subjected to, for instance at the hot isostatic pressing in order to form a compacted compound product, and at the hardening of the finished compound product, adjacent carbides, nitrides and/or carbonitrides in the wear resistant steel material may coalesce and form large agglomerates. The size of said hard phase particles in the wear layer of the finished, heat treated product may therefore exceed 3 μm. The main part expressed in vol.-% is in the range 1 to 10 μm in the longest extension of the particles and the average size of the particles is below 1 μm. The total amount of hard phase is dependent on the nitrogen content and the amount of nitride formers, i.e. mainly vanadium and chromium. Generally, the total amount of hard phase in the wear layer of the finished product is in the range 5 to 40 vol.-%.

The steel powder used for producing the wear pad is manufactured by disintegration of a melt with the indicated composition, except nitrogen, for the wear resistant steel material. Inert gas, preferably, nitrogen, is blown through a jet of the melt which is split into droplets which are allowed to solidify, and subsequently the powder obtained is subjected to solid phase nitriding to the desired nitrogen content.

### PERFORMED EXPERIMENTS

To find a material that permitted the production of long life and comparatively inexpensive wear pads for band saw blade guides exposed to wear from a moving band saw blade, the experiments below were carried out.

In a band saw for sawing metal, wear pads having cemented carbide blocks brazed to a support lasted about six months before failure due to cracking. Wear pads manufactured of the steel material Vanax 75, a powder metallurgically produced steel with a composition within the intervals indicated in claim 1, is still running after having been in service for more than one year and is still in surprisingly good shape.

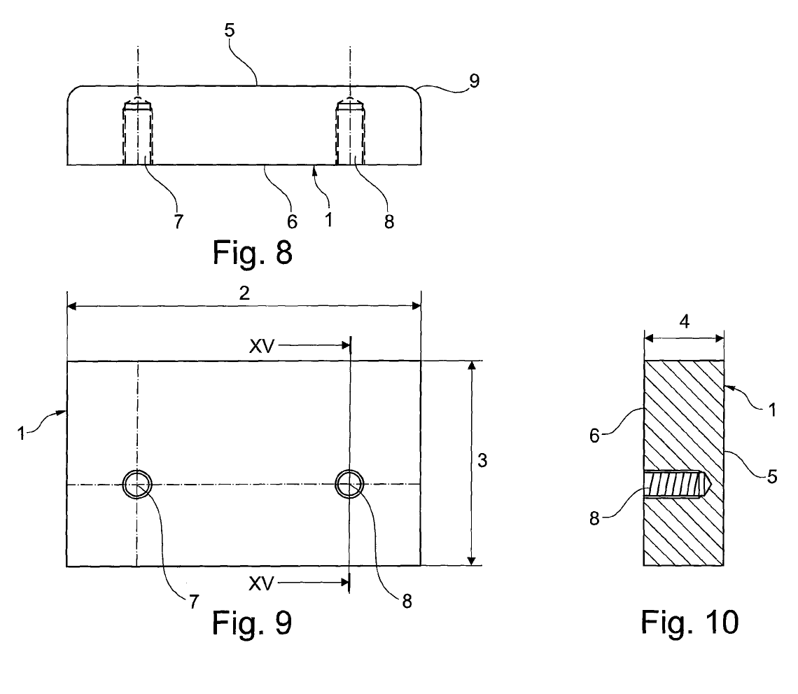

FIGS. 8 to 10 show an example of a preferred embodiment of a wear pad of the present invention for a band saw blade guide exposed to wear from a moving band saw blade. As shown a wear pad 1 in accordance with the invention may have a very simple form, e.g. basically a parallelepipedal block made from Vanax 75, which makes it very easy and cost-efficient to produce. In the shown embodiment it presents a length 2 on the order of 10 cm, a width 3 on the order of 6 cm, and a thickness 4 on the order of 2 cm. Preferably, the wear pad has a length of 10 cm±20%, a width of 6 cm±20%, and a thickness of 2 cm±20%. Preferably, at least the leading edge 9 of the wear surface 5, which is intended to face the band saw blade, is rounded. In the oppositely facing surface 6 of the block, there are two threaded blind bores 7 and 8 permitting the wear pad to be easily mounted to a carrier, not shown, by means of screws, likewise not shown.

Even though the shown wear pad is shown as a solid block of Vanax 75, it is possible and in some cases preferred to have it metallurgically bonded to a support, not shown, to form a compound product. As an example, the support may be of a material having better thermal conductivity than that of Vanax 75 to improve heat dissipation from the wear surface.

Test rods of Vanax 75, a powder metallurgically produced steel with a composition within the intervals indicated in claim 1, was cut from a hit isostatic pressed body and then ground and polished to the same surface finish as the alloys applied by welding.

The test bars of Vanax 75 were heat treated in a vacuum furnace with the use of nitrogen gas as the quenching medium. The hot working cycle used was austenitizing at an austenitizing temperature, T_{A}=1080° C. during 30 min followed by deep freezing in liquid nitrogen and tempering twice at a tempering temperature of 400° C. during two hours (2×2 h).

### Microstructure

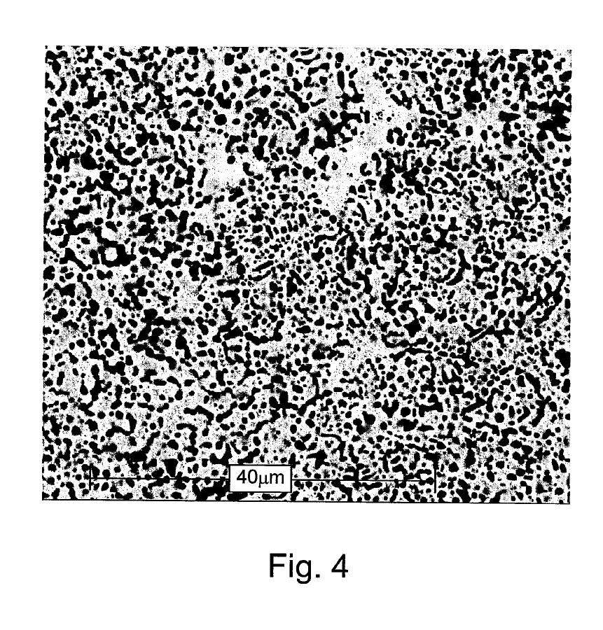

The microstructure of Vanax 75 consists of a martensitic matrix and 23 vol.-% of a hard phase of MX-type, where M is V, and X is N and C. The hard phase particles have an average size below 3 μm, preferably below 2 μm, and even more preferred below 1 μm. The hard phase particles are homogeneously distributed in the matrix, see FIG. 4.

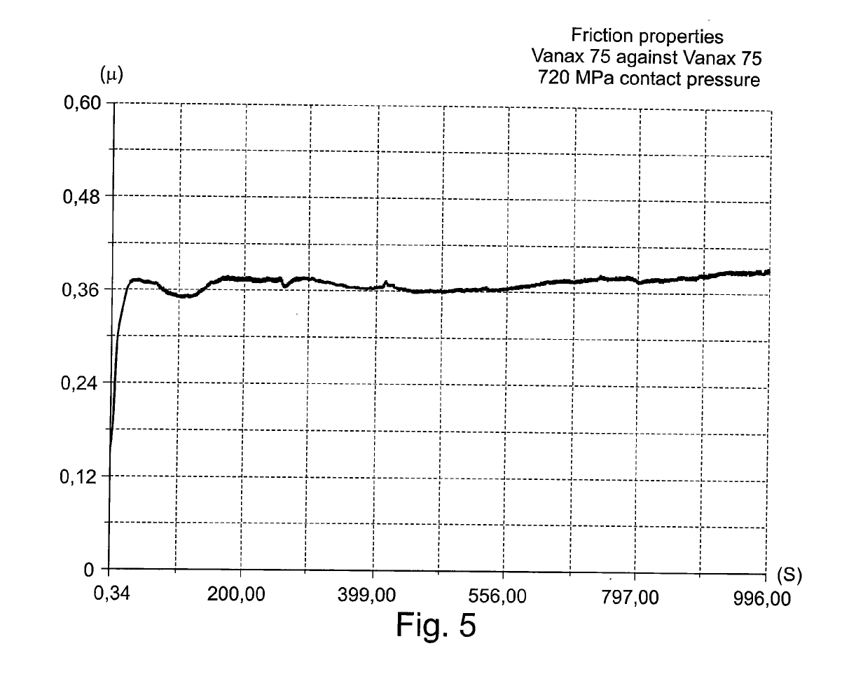

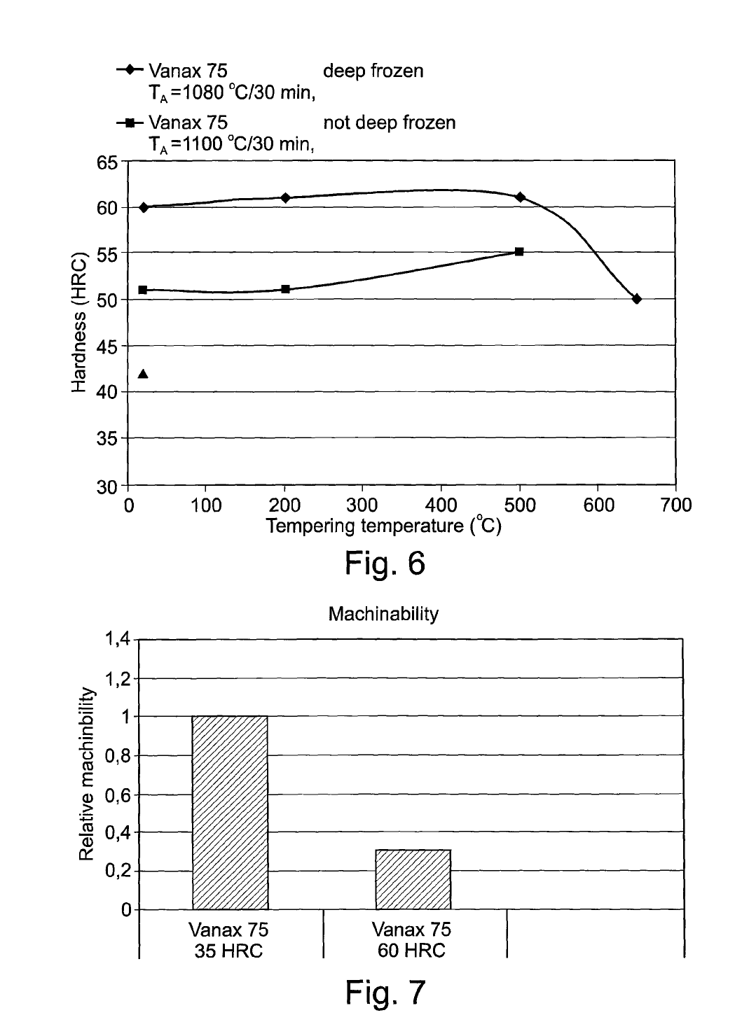

The friction properties when two surfaces of Vanax 75 were tested against each other are shown in FIG. 5. This material shows good friction properties on an even level, μ about 0.36, which may be attributed to the even distribution of very fine and hard hard-phase particles.

### Tempering Response

The tempering response of the wear resistant steel material, Vanax 75, was tested. The result is shown in FIG. 7 and proves that the wear resistant steel material has a very good tempering response. For Vanax 75 in deep frozen condition, a hardness of 60 to 62 HRC is obtained at tempering up to about 500° C. Vanax 75 in non-deep frozen condition shows a good tempering response and obtains a hardness of 51 to 55 HRC.

### High Temperature Resistance

The high temperature resistance of the wear resistant steel material was examined by studying how the hard phase particles were influenced at heating to different temperatures up to about 1300° C. It could be determined that the hard phase particles were very stable. In principle, none or very little growth of hard phase particles took place, in spite of the high temperatures used. This is very advantageous if the material is to be used at high operation temperatures (700 to 800° C.) and long operation periods.

### Machinability

The machinability of the wear resistant steel material according to the invention was examined. The machinability of Vanax 75 in delivery condition, i.e. hot isostatic soft annealed condition (35 HRC), and in hardened and tempered condition (60 HRC) was examined (see FIG. 7). Vanax 75 in delivery condition has the best machinability (1.0).

1. A method for the manufacture of a wear pad of a band saw blade guide exposed to wear from a moving band saw blade, comprising:
producing of a wear resistant steel material in a powder metallurgical manner with the following composition in weight-%:

| C | Si | Mn | Cr | Ni | Mo + ½W | Co | S | N |
|---|---|---|---|---|---|---|---|---|
| 0.01-2 | 0.01-3.0 | 0.01-10.0 | 16-33 | max. 5 | 0.01-5.0 | max. 9 | max. 0.5 | 1.6-9.8 |

7.5 to 14 of (V+Nb/2), wherein contents of N and of (V+Nb/2) are balanced in relation to each other so that the contents of the elements are within a range I″, F″, G, H, I″ in a coordinate system, where the content of N is the abscissa and the content of V+Nb/2 is the ordinate, and where the coordinates for said points are:

| | I″ | F″ | G | H |
|---|---|---|---|---|
| N | 1.6 | 5.8 | 9.8 | 2.6 |
| V + Nb/2 | 7.5 | 7.5 | 14.0 | 14.0 |

max. 7 of any of Ti, Zr, and Al; and
balance essentially only iron and unavoidable impurities;
hot isostatic pressing of the produced powder during a period of 3 h at 1000 to 135° C., preferably 1100 to 1150° C. and at a pressure of 100 MPa to a completely dense or at least close to completely dense body; and
heat treating the dense body by hardening from an austenitizing temperature of 950 to 1150° C. and low temperature tempering at 200 to 450° C. 2×2 h, or high temperature tempering at 450 to 700° C., 2×2 h to produce a steel wear pad having a microstructure comprising an even distribution of up to 50 vol.-% of hard phase particles of M₂X—, MX— and or M₂₃C₆/M₇C₃-type, the size of which in a longest extension is 1 to 10 μm, where the content of the hard phase particles is such that up to 20 vol.-% are M₂X-carbides, -nitrides and/or -carbonitrides, wherein M mainly is Cr, and X mainly is N, and 5 to 40 vol.-% of MX-carbides, -nitrides and/or -carbonitrides, wherein M mainly is V and Cr, and X mainly is N, wherein the average size of said MX-particles is below 3 μm, preferably below 2 μm, and even more preferred below 1 μm.

2. A method according to claim 1, further comprising:
encasing the powder in a capsule;
evacuating gas in the capsule; and after the hot isostatic pressing,
removing the capsule or at least part of the capsule covering the wear resistant steel material.

3. A method according to claim 1, further comprising:
manufacturing an intermediate product of the wear resistant steel material by binding the powder granules in the powder of the wear resistant steel material, and subsequently encasing the bound powder granules obtained in the capsule.

4. A method according to claim 3, wherein the intermediate product has the shape of a strip or pad.

5. A method according to claim 3, characterized by binding the powder granules by hot isostatic pressing.

6. A method according to claim 2, wherein the capsule mainly consists of nickel or a monel metal.

7. A method according to claim 1, further comprising manufacturing a powder of the wear resistant steel material manufactured by disintegration of a melt with the composition indicated for the wear resistant steel material, except nitrogen, by an inert gas, preferably nitrogen, which is blown through a jet of the melt, which is split into droplets that are allowed to solidify, and subsequently subjecting the powder obtained to solid phase nitriding to the indicated nitrogen content.

8. A method according to claim 1, wherein the following elements are also included in the wear pad, contents in weight-%:

| Elements | C | Si | Mn | Cr | Mo | V | N |
|---|---|---|---|---|---|---|---|
| Min. | 0.10 | 0.01 | 0.01 | 18.0 | 0.01 | 7.5 | 2.5 |
| Guideline value | 0.20 | 0.30 | 0.30 | 21.0 | 1.3 | 9.0 | 4.3 |
| Max. | 1.5 | 1.5 | 1.5 | 21.5 | 2.5 | 11 | 6.5 |

9. A method according to claim 1, wherein, in the wear resistant steel material, carbon is present in a content of 0.1 to 2 weight-%, nitrogen in a content of up to 9.8 weight-%, and vanadium in a content of up to about 14 weight-%.

10. A wear pad of a band saw blade guide exposed to wear from a moving band saw blade, comprising said wear pad is a steel component of the following composition:

| C | Si | Mn | Cr | Ni | Mo + ½W | Co | S | N |
|---|---|---|---|---|---|---|---|---|
| 0.01-2 | 0.01-3.0 | 0.01-10.0 | 16-33 | max. 5 | 0.01-5.0 | max. 9 | max. 0.5 | 1.6-9.8 |

7.5 to 14 of (V+Nb/2), wherein the contents of N and of (V+Nb/2) are balanced in relation to each other so that the contents of the elements are within a range I″, F″, G, H, I″ in a coordinate system, where the content of N is the abscissa and the content of V+Nb/2 is the ordinate, and where the coordinates for said points are:

| | I″ | F″ | G | H |
|---|---|---|---|---|
| N | 0.6 | 1.6 | 9.8 | 2.6 |
| V + Nb/2 | 0.5 | 0.5 | 14.0 | 14.0 |

max 7 of any of Ti, Zr, and Al; and
balance essentially only iron and unavoidable impurities,
wherein the steel wear pad has a microstructure comprising an even distribution of up to 50 vol-% of hard phase particles of M₂X—, MX— and or M₂₃C₆/M₇C₃-type, the size of which in their longest extension is 1 to 10 μm, where the content of said hard phase particles is such that up to 20 vol.-% are M₂X-carbides, -nitrides and/or -carbonitrides, wherein M mainly is such that up to 20 vol.-% are M₂X-carbides, -nitrides and/or -carbonitrides, wherein M mainly is Cr, and X mainly is N, and 5 to 40 vol.-% of MX-carbides, -nitrides and/or -carbonitrides, wherein M mainly is V and Cr, and X mainly is N, wherein the average size of said MX-particles is below 3 μm, preferably below 2 μm, and even more preferred below 1 μm.

11. A wear pad according to claim 10, wherein elements are included in the wear resistant steel material, contents in weight-%:

| Element | C | Si | Mn | Cr | Mo | V | N |
|---|---|---|---|---|---|---|---|
| Min. | 0.10 | 0.01 | 0.01 | 18.0 | 0.01 | 7.5 | 2.5 |
| Guideline value | 0.20 | 0.30 | 0.30 | 21.0 | 1.3 | 9.0 | 4.3 |
| Max. | 1.5 | 1.5 | 1.5 | 21.5 | 2.5 | 11 | 6.5 |

12. A wear pad according to claim 10, wherein, in the wear resistant steel material, carbon is present in a content of 0.1 to 2 weight-%, nitrogen in a content of up to 9.8 weight-%, and vanadium in a content of up to about 14 weight-%.

13. A use of a steel material for powder metallurgic production of a wear pad of a band saw blade guide exposed to wear from a moving band saw blade, the steel material comprising in percent by weight:

| C | Si | Mn | Cr | Ni | Mo + ½W | Co | S | N |
|---|---|---|---|---|---|---|---|---|
| 0.01-2 | 0.01-3.0 | 0.01-10.0 | 16-33 | max. 5 | 0.01-5.0 | max. 9 | max. 0.5 | 1.6-9.8 |

7.5 to 14 of (V+Nb/2), wherein the contents of N and of (V+Nb/2) are balanced in relation to each other so that the contents of the elements are within a range I″, F″, G, H, I″ in a coordinate system, where the content of N is the abscissa and the content of (V+Nb/2) is the ordinate, and where the coordinates for said points are:

| | I″ | F″ | G | H |
|---|---|---|---|---|
| N | 1.6 | 5.8 | 9.8 | 2.6 |
| V + Nb/2 | 7.5 | 7.5 | 14.0 | 14.0 |

max 7 of any of Ti, Zr, and Al; and
balance essentially only iron and unavoidable impurities,
wherein the steel powder material further being such that after hot isostatic pressing of the powder during a period of 3 h at 1000 to 1350° C., preferably 1100 to 1150° C. and at a pressure of 100 MPa to a completely dense or at least close to completely dense body, and after subsequent heat treatment of the dense body by hardening from an austenitizing temperature of 950 to 1150° C. and low temperature tempering at 200 to 450° C., 2×2 h, or high temperature tempering at 450 to 700° C., 2×2 h, the steel material has a microstructure comprising an even distribution of up to 50 vol.-% of hard phase particles of M₂X—, MX— and or M₂₃C₆/M₇C₃-type, the size of which in the longest extension is 1 to 10 μm, where the content of said hard phase particles is such that up to 20 vol.-% are M₂X-carbides, -nitrides and/or -carbonitrides, wherein M mainly is Cr, and X mainly is N, and 5 to 40 vol.-% of MX-carbides, -nitrides and/or -carbonitrides, wherein M mainly is V and Cr, and X mainly is N, wherein the average size of said MX-particles is below 3 μm, preferably below 2 μm, and even more preferred below 1 μm.
